(19) United States
(12) Patent Application Publication
(10) Pub. No.: US 2020/0150271 A1
(43) Pub. Date: May 14, 2020

(54) DISTANCE-MEASUREMENT CONTROLLER AND DISTANCE MEASURING SYSTEM

(71) Applicant: Panasonic Intellectual Property Management Co., Ltd., Osaka (JP)

(72) Inventors: HIROSHI IWAI, Osaka (JP); TETSURO OKUYAMA, Osaka (JP); OSAMU SHIBATA, Hyogo (JP); TAKEHIRO TANAKA, Osaka (JP)

(21) Appl. No.: 16/745,622

(22) Filed: Jan. 17, 2020

Related U.S. Application Data
(63) Continuation-in-part of application No. PCT/JP2018/026440, filed on Jul. 13, 2018.

(30) Foreign Application Priority Data
Jul. 31, 2017 (JP) 2017-147902

(51) Int. Cl. G01S 17/10; G01S 17/86; G01S 7/4865; G01S 17/931; H04N 5/232

(52) U.S. Cl. CPC G01S 17/10; G01S 17/86; H04N 5/232; G01S 17/931; G01S 7/4865

(57) ABSTRACT

A distance-measurement controller is to be used with an imaging device. The imaging device includes a light source that emits invisible light and a light receiver that receives reflected light. The reflected light is the invisible light that has been reflected by a target object. The distance-measurement controller includes a controller and a distance measurer. The controller causes the light receiver to make images at a constant frame rate, and causes the imaging device to vary a condition for at least two divided ranges into which a range that is a predetermined distance from the imaging device is divided. The condition is a condition under which the images are made to measure a distance from the imaging device to the target object. The distance measurer measures the distance from the imaging device to the target object, based on the reflected light.

### RELATED APPLICATIONS

This application is a continuation-in-part of PCT International Application No. PCT/JP2018/026440, filed on Jul. 13, 2018, which claims the benefit of foreign priority of Japanese patent application 2017-147902 filed on Jul. 31, 2017, the contents all of which are incorporated herein by reference.

### BACKGROUND

### 1. Technical Field

The present disclosure relates to a distance-measurement controller and a distance measuring system that measure a distance from an imaging device to a target object.

### 2. Background Art

An imaging device that uses a time-of-flight (TOF) method is known as an apparatus to measure a distance from the imaging device to a target object. Such an imaging device includes a light source that emits invisible light and a light receiver that receives reflected light. The reflected light is the invisible light that has been reflected by the target object.

The distance from the imaging device to the target object is measured based on a phase difference between the invisible light emitted from the light source and the reflected light received by the light receiver. The farther the distance from the imaging device to the target object is, the weaker an intensity of reflected light received by the light receiver becomes. If the intensity of the reflected light is weak, a signal-to-noise ratio (SNR) of output from the light receiver becomes low. Therefore, variation in measured distances becomes large. Therefore, it would be difficult to accurately measure a distance.

Unexamined Japanese Patent Publication No. 119-229675 discloses lengthened intervals of emissions from a light source when a target object lies relatively far. Since the lengthened intervals of emissions increase an amount of reflected light that is stored in a light receiver during each of the intervals, a distance from an imaging device to the target object can be measured accurately, even when the target object lies relatively far.

### SUMMARY

The present disclosure provides a distance-measurement controller and a distance measuring system that decrease heat generated by an imaging device, and accurately measures a distance from the imaging device to a target object that lies within a range within which the imaging device makes images.

A distance-measurement controller according to an aspect of the present disclosure is to be used with an imaging device. The imaging device includes a light source that emits invisible light and a light receiver that receives reflected light. The reflected light is the invisible light that has been reflected by a target object. The distance-measurement controller includes a controller and a distance measurer. The controller causes the light receiver to make images at a constant frame rate, and causes the imaging device to vary a condition for at least two divided ranges into which a range that is a predetermined distance from the imaging device is divided. The condition is a condition under which the images are made to measure a distance from the imaging device to the target object. The distance measurer measures the distance from the imaging device to the target object, based on the reflected light.

A distance measuring system according to another aspect of the present disclosure includes the above distance-measurement controller and the above imaging device. The imaging device includes the light source that emits invisible light and the light receiver that receives reflected light. The reflected light is the invisible light that has been reflected by the target object.

According to the present disclosure, heat generated by the imaging device is decreased. Further, a distance from the imaging device to a target object is accurately measured within a range within which the imaging device makes images.

### BRIEF DESCRIPTION OF DRAWINGS

FIG. 1 is a block diagram that illustrates a distance measuring system according to a present exemplary embodiment;

FIG. 2 schematically illustrates distance measurement based on time-of-flight of light;

FIG. 3 is a schematic view that illustrates emitted light and reflected light;

FIG. 4 illustrates ranges of a distance-measurement controller;

FIG. 5A illustrates emitted light and reflected light in case of a near range;

FIG. 5B illustrates emitted light and reflected light in case of a middle range;

FIG. 5C illustrates emitted light and reflected light in case of a far range;

FIG. 6 illustrates variation in measured distances relative to measured distances;

FIG. 7 illustrates variation in measured distances relative to measured distances;

FIG. 8 illustrates a viewing range of a distance-measurement controller in a vertical direction; and

FIG. 9 illustrates a viewing range of the distance-measurement controller in a lateral direction.

### DETAILED DESCRIPTION OF PREFERRED EMBODIMENTS

Prior to description of an exemplary embodiment of the present disclosure, problems of conventional techniques will briefly be described. According to Unexamined Japanese Patent Publication No. 119-229675, intervals of emissions from a light source are lengthened. On the other hand, a period of time of one emission is also lengthened. Therefore, heat generated by an imaging device increases. Further, if intervals of emissions from the light source are lengthened or if a period of time of one emission is lengthened, a light receiver may receive reflected light that has been reflected by a target object that lies relatively near and thus has an intensity that is excessively strong for some dynamic range of the light receiver. If an intensity of reflected light is excessively strong, outputs from the light receiver are saturated. Consequently, distance measurement may lose distance information.

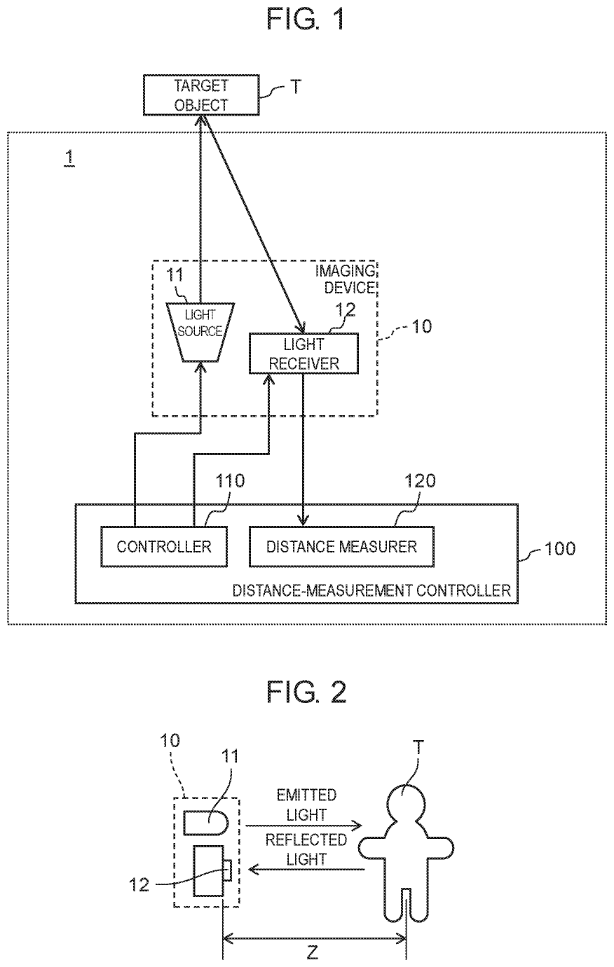

Hereinafter, the present exemplary embodiment will be described in detail with reference to the drawings. FIG. 1 is a block diagram that illustrates distance measuring system 1 according to the present exemplary embodiment.

As illustrated in FIG. 1, distance measuring system 1 is attached to a vehicle, and measures a distance from distance measuring system 1 to target object T that lies around the vehicle. Distance measuring system 1 includes imaging device 10 and distance-measurement controller 100. In a description below, target object T for distance measuring system 1 lies behind the vehicle. However, target object T for distance measuring system 1 may not lie behind the vehicle. That is to say, target object T for distance measuring system 1 may lie in front of, diagonally in front of, sideways from, or diagonally behind the vehicle. Distance measuring system 1 is preferably attached to a position on the vehicle that corresponds to a position of target object T. Distance measuring system 1 is preferably attached to a position that corresponds to a position of target object T for distance measuring system 1 that lies behind, in front of, diagonally in front of, sideways from, or diagonally behind the vehicle, for example.

Imaging device 10 is attached to a position that is on a rear surface of the vehicle and is apart from a road surface, for example. Imaging device 10 includes light source 11 and light receiver 12.

Light source 11 emits pulsed infrared light (that is an example of invisible light of the present disclosure and will be referred to as “emitted light” below) to a range within which imaging device 10 makes images. Distance-measurement controller 100 controls conditions under which emitted light from light source 11 is pulsed (e.g. a pulse width, an amplitude, pulse intervals, and a number of pulses).

Light receiver 12 is a complementary metal oxide semiconductor (CMOS) image sensor, for example. Light receiver 12 receives reflected light that is emitted light that has been reflected by target object T, and generates infrared-image data (hereinafter referred to as “IR-image data”). Distance-measurement controller 100 controls conditions under which light receiver 12 receives light (e.g. an exposure time, an exposure timing, and a number of exposures).

Distance-measurement controller 100 is an electronic control unit (ECU), for example. To measure a distance from imaging device 10 to target object T that lies behind the vehicle, distance-measurement controller 100 includes input terminals, output terminals, a processor, program memory, and main memory. The input terminals, the output terminals, the processor, the program memory, and the main memory are mounted on a control circuit-board.

The processor uses the main memory to execute program stored in the program memory. The processor receives various signals through the input terminals, and processes the various signals. The processor transmits various control signals to light source 11 and light receiver 12 through the output terminals.

The processor executes the program. Consequently, distance-measurement controller 100 functions as controller 110 and distance measurer 120.

To control the conditions under which emitted light from light source 11 is pulsed, and the conditions under which light receiver 12 receives light, controller 110 outputs control signals to light source 11 and light receiver 12. Consequently, light source 11 emits light to a range within which imaging device 10 makes images, and light receiver 12 generates IR-image data, based on the reflected light. A unit of the IR-image data is a frame.

Distance measurer 120 uses distance measurement based on time-of flight of light (hereinafter referred to as TOF distance measurement) to measure a distance from imaging device 10 to target object T, based on IR-image data generated by light receiver 12.

The TOF distance measurement will be described. Light source 11 and light receiver 12 are used for the TOF distance measurement to measure a distance from imaging device 10 to target object T.

Distance measurer 120 uses the TOF distance measurement to determine distance Z from imaging device 10 to target object T illustrated in FIG. 2, based on a period of time from a timing at which light source 11 emits light to a timing at which light receiver 12 receives reflected light.

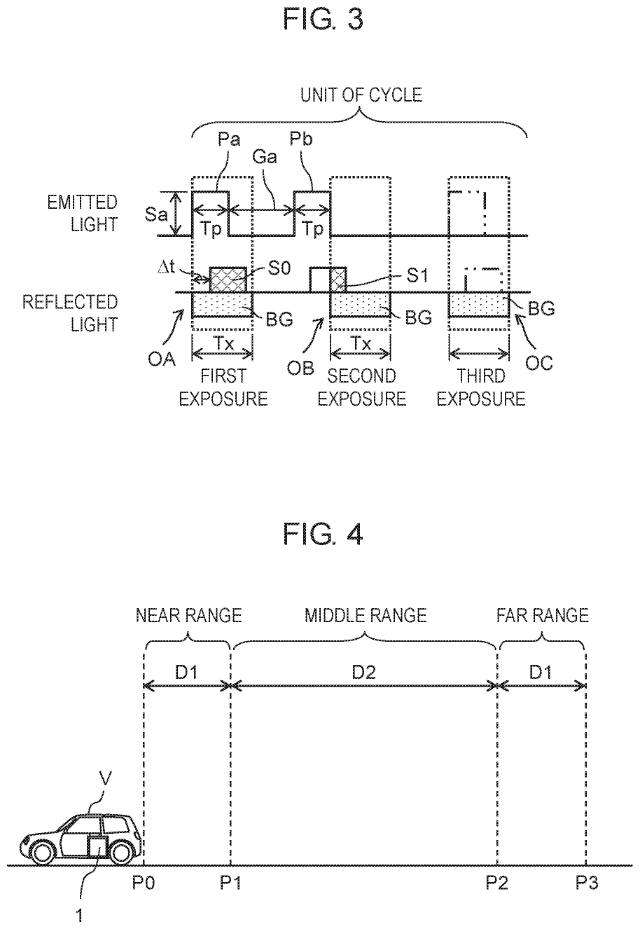

Hereinafter, a specific example of the distance measurement will be described. As illustrated in FIG. 3, emitted light from light source 11 has at least one pair of first pulse Pa and second pulse Pb in a unit of cycle. Each of pulse intervals (that is to say, a period of time from a falling edge of first pulse Pa to a rising edge of second pulse Pb) is Ga. A pulse amplitude of first pulse Pa and a pulse amplitude of second pulse Pb are same and are each designated by Sa. A pulse width of first pulse Pa and a pulse width of second pulse Pb are same and are each designated by Tp.

Controller 110 causes light receiver 12 to be exposed to light at timings that are based on timings at which first pulse Pa and second pulse Pb are emitted. For example, light receiver 12 is exposed to reflected light that has been reflected by target object T, in a first exposure, a second exposure, and a third exposure, as illustrated in FIG. 3.

More specifically, the first exposure starts simultaneously with rising of first pulse Pa, and ends at a time at which exposure time Tx has passed. Exposure time Tx is set in advance in relation to emitted light from light source 11. The first exposure is for receiving reflected light that corresponds to first pulse Pa.

Output OA from light receiver 12 due to the first exposure contains reflected-light component S0 that is diagonally cross-hatched, and a background component BG that is dotted. An amplitude of reflected-light component S0 is smaller than an amplitude of first pulse Pa.

A period of time from a rising edge of first pulse Pa to a rising edge of reflected-light component S0 that corresponds to first pulse Pa is designated by Δt. Δt is a time taken by invisible light to reach target object T and to return to imaging device 10. A distance from imaging device 10 to target object T is distance Z.

To receive reflected light that corresponds to second pulse Pb, the second exposure starts simultaneously with a falling edge of second pulse Pb, and the second exposure is allowed for exposure time Tx.

Output OB from light receiver 12 due to the second exposure does not contain a whole reflected-light component but contains partial component S1 (refer to an area that is diagonally cross-hatched) The output OB also contains background component BG (refer to an area that is dotted). Partial component S1 is expressed by Expression (1).

[Expression 1]

S1=S0*(Δt/Tp) (1)

To receive only an invisible-light component that does not contain reflected-light components (background component), the third exposure starts at a timing that does not allow a reflected-light component that corresponds to first pulse Pa and a reflected-light component that corresponds to second pulse Pb to be contained, and the third exposure is allowed for exposure time Tx.

Output OC (an output signal, an output level) from light receiver 12 due to the third exposure contains only background component BG (refer to an area that is dotted).

Expressions (2) to (4) described below are used to determine distance Z from imaging device 10 to target object T, from such a relation between emitted light and reflected light described above.

$$\begin{matrix}[ Expression 2 ] & \\ S 0 = OA - BG & ( 2 ) \\ [ Expression 3 ] & \\ S 1 = OB - BG & ( 3 ) \\ [ Expression 4 ] & \\ \begin{matrix}Z = C * ( Δ t / 2 ) \\ = [ ( C * Tp ) / 2 ] * ( Δ t / Tp ) \\ = [ ( C * Tp ) / 2 ] * ( S 1 / S 0 )\end{matrix} & ( 4 )\end{matrix}$$

In the expressions, C is a speed of light.

If the above method is used to determine distance Z, and reflected light that corresponds to first pulse Pa has a weak intensity and reflected light that corresponds to second pulse Pb has a weak intensity, SNRs of outputs OA, OB from light receiver 12 become low. Consequently, accuracy of distance Z that has been determined may decrease. Such a phenomenon is likely to occur if target object T lies relatively far.

If target object T lies relatively far, intervals of emissions from light source 11 may be lengthened, as disclosed in Unexamined Japanese Patent Publication No. H9-229675, for example. Since the lengthened intervals of emissions increase an amount of reflected light that is stored in light receiver 12 during each of the intervals, a distance from imaging device 10 to target object T that lies relatively far is accurately measured.

The intervals of emissions from light source 11 are lengthened. On the other hand, a period of time of one emission is also lengthened. Therefore, a frame rate of imaging device 10 decreases, and heat generated by imaging device 10 increases. Further, if intervals of emissions from light source 11 are lengthened or if a period of time of one emission is lengthened, an intensity of reflected light that has been reflected by target object T that lies relatively near may be excessively strong for some dynamic range of imaging device 10. If an intensity of reflected light is excessively strong, outputs OA, OB from light receiver 12 are saturated. Consequently, distance measurement may lose distance information.

Therefore, according to the present exemplary embodiment, controller 110 divides a range that is a predetermined distance (e.g. 50 m) from imaging device 10 to form three divided ranges. As illustrated in FIG. 4, the three divided ranges are a near range as an example of a third range, a middle range as an example of a first range, and a far range as an example of a second range.

FIG. 4 exemplifies distance measuring system 1 that measures a distance behind vehicle V to which distance measuring system 1 is attached. Imaging device 10 (not illustrated) is attached to position P0 in FIG. 4, that is to say a rear end of vehicle V.

The near range is nearer to imaging device 10 than the middle range and the far range are. The near range is between position P0 of imaging device 10 and position P1 that is distance D1 (e.g. 10 m) away from position P0, for example. The middle range is between position P1 and position P2 that is distance D2 away from position P1. In the present exemplary embodiment, distance D2 is distance D1 multiplied by three (e.g. 30 m).

The far range is farther from imaging device 10 than the near range and the middle range are. The far range is between position P2 and position P3 that is distance D1 away from position P2. The far range has an area that is as large as an area of the near range.

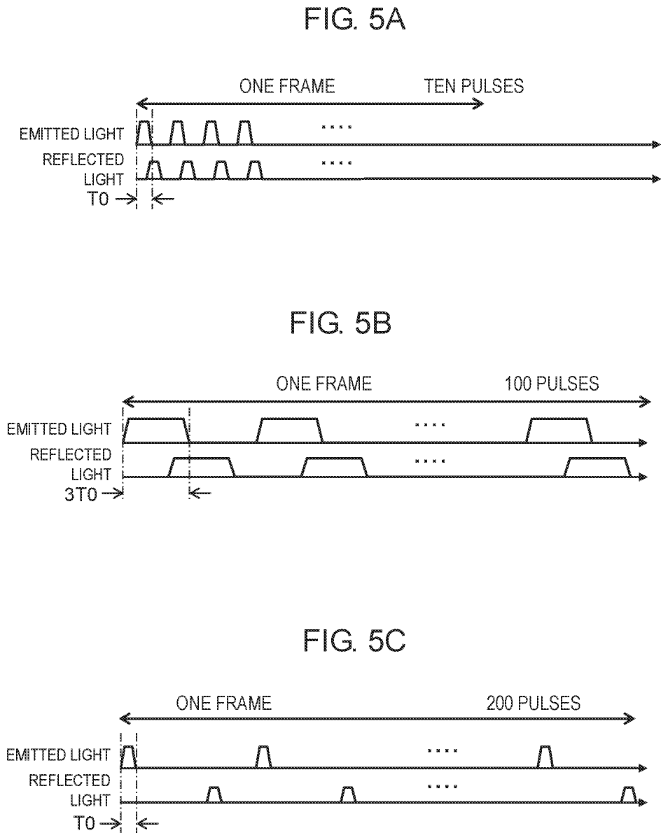

Controller 110 causes imaging device 10 to vary conditions under which imaging device 10 makes images, and causes the conditions to be varied for each of the divided ranges. Consequently, a distance is most appropriately measured for each of the divided ranges. FIG. 5A illustrates emitted light and reflected light in case of the near range. FIG. 5B illustrates emitted light and reflected light in case of the middle range. FIG. 5C illustrates emitted light and reflected light in case of the far range.

In FIGS. 5A, 5B, and 5C, the emitted light is emitted from light source 11, and the reflected light is the emitted light that has been reflected by target object T and returns to light receiver 12. Therefore, the reflected light is received later than the emitted light. Further, FIGS. 5A, 5B, and 5C each illustrate emitted light and reflected light within one frame in each of the ranges.

The conditions under which imaging device 10 makes images include a number of pulses of emitted light, for example. Since an intensity of reflected light is weak in case of the far range, an amount of attenuation of reflected-light component S0 and an amount of attenuation of partial component S1 increase, for example. Reflected-light component S0 and partial component S1 are illustrated in FIG. 3.

However, if a number of pulses of emitted light is increased, a number of pulses within a unit of cycle in FIG. 3 increases. Consequently, a plurality of controls of exposures are performed within the unit of cycle. Each of the controls of exposures includes a first exposure, a second exposure, and a third exposure. Reflected-light component S0 and partial component S1 are received in each of the controls of exposures. Reflected-light components S0 received in the controls of exposures are added together. Further, partial components S1 received in the controls of exposures are added together. Therefore, an intensity of reflected light is not weak.

Therefore, at a time of measurement of a distance within the middle range of the divided ranges, controller 110 causes light source 11 to emit light whose number of pulses is smaller than a number of pulses of light emitted by light source 11 at a time of measurement of a distance within the far range of the divided ranges, as illustrated in FIGS. 5B and 5C. For example, a number of pulses in case of the middle range is 100, and a number of pulses in case of the far range is 200.

Consequently, the number of pulses of light emitted at a time of measurement of a distance within the middle range is smaller than the number of pulses of light emitted at a time of measurement of a distance within the far range. That is, the number of pulses at a time of measurement of a distance within the far range is larger than the number of pulses at a time of measurement of a distance within the middle range. Therefore, an intensity of reflected light is not weak at a time of measurement of a distance within the far range. Therefore, an SNR is not low. Therefore, if target object T lies in the far range, variation in distances is not large.

Further, since a number of pulses in case of the middle range is smaller than a number of pulses in case of the far range, a number of pulses is small in view of all the ranges. Therefore, an amount of heat generated by imaging device 10 is decreased, compared with a case where a number of pulses that corresponds to the far range is used for all the ranges, and thus a number of pulses increases in view of all the ranges.

Further, since an excessively large number of pulses excessively increases intensity of reflected light in case of the near range, outputs OA, OB from light receiver 12 are saturated. Consequently, distance measurement may lose distance information.

Therefore, at a time of measurement of a distance within the near range of the divided ranges, controller 110 causes light source 11 to emit light whose number of pulses is smaller than a number of pulses of light emitted by the light source 11 at a time of measurement of a distance within the middle range of the divided ranges, as illustrated in FIGS. 5A and 5B. For example, a number of pulses in case of the near range is 10.

Consequently, a number of pulses in case of the near range is smaller than a number of pulses in case of the middle range and a number of pulses in case of the far range. Therefore, an intensity of reflected light is not excessively strong at light receiver 12. Consequently, outputs OA, OB from light receiver 12 are not saturated. Consequently, distance measurement does not lose distance information.

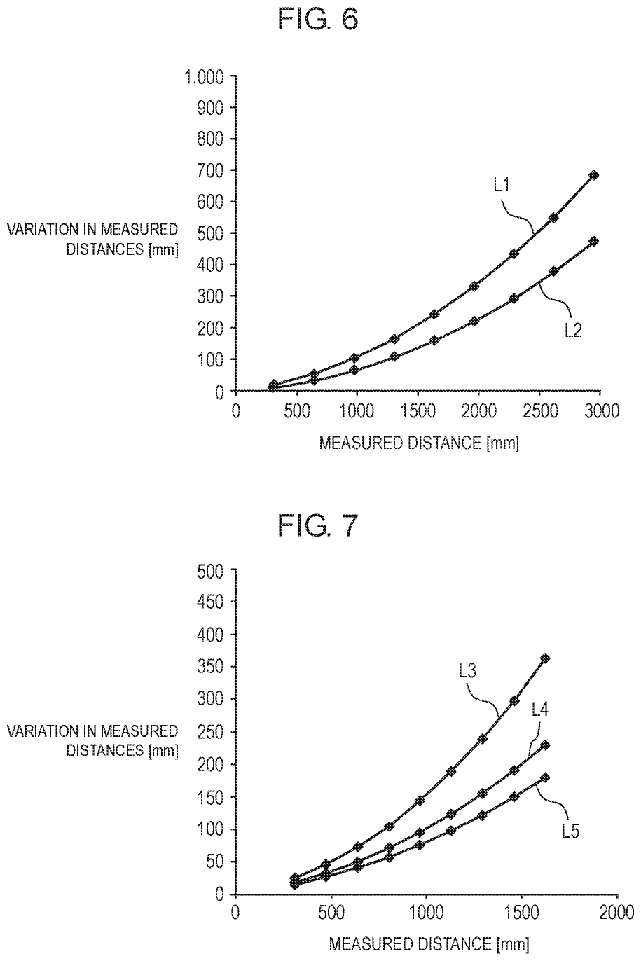

The conditions under which imaging device 10 makes images include a pulse width of emitted light. Expression (5) described below is generally known as an expression that represents variation σ in measured distances. FIG. 6 illustrates variation σ in measured distances relative to measured distances. Curves L1, L2 in FIG. 6 represent variations σ in measured distances measured using different pulse widths. A pulse width of curve L2 is half a pulse width of curve L1.

$$\begin{matrix}[ Expression 5 ] & \\ σ ≅ \frac{C \cdot Tp}{2} \times ( \frac{1}{S 0} ) \times \sqrt{S 1 + \frac{S {1}^{2}}{S 0}} & ( 5 )\end{matrix}$$

Expression (5) and results illustrated in FIG. 6 show that larger a pulse width, larger variation σ in measured distances. Therefore, at a time of measurement of a distance within the far range and at a time of measurement of a distance within the near range, controller 110 causes light source 11 to emit light whose pulse width is smaller than a pulse width of light emitted by light source 11 at a time of measurement of a distance within the middle range.

Consequently, variation σ in measured distances decreases in case of the far range where accuracy of distance measurement decreases.

Further, the ranges are set in such a manner that the ranges correspond to pulse widths. That is, the far range where accuracy of measurement is likely to decrease is set in such a manner that the far range corresponds to a relatively small pulse width. Consequently, a distance is more accurately measured.

In the present exemplary embodiment, the near range and the far range are set to distance D1, and the middle range is set to distance D2, as illustrated in FIG. 4. Distance D2 is approximately three times as long as distance D1. Therefore, as illustrated in FIGS. 5A, 5B, and 5C, if a pulse width is set to T0 in case of the near range and the far range, a pulse width in case of the middle range is set to 3T0.

Distance measurer 120 measures a distance from light source 11 to target object T, based on emitted light and reflected light. Distance measurer 120 performs the measurement for each of the divided ranges. More specifically, distance measurer 120 changes a timing of measurement of partial component S1, for each of the divided ranges.

In case of the near range that is from position P0 to position P1, invisible light emitted from light source 11 and reflected light that returns do not pass through the ranges within which a distance is not measured. Therefore, in case of the near range, a timing of measurement of partial component S1 in FIG. 3 is set to a timing of falling of second pulse Pb, and a distance is measured.

In case of the middle range, a distance is not measured within a portion that corresponds to the near range. Therefore, measurement needs to be performed in view of periods of time during which emitted light and reflected light pass through the portion that corresponds to the near range. More specifically, in case of the middle range, a timing of measurement of partial component S1 in FIG. 3 is delayed by a period of time that corresponds to T0, and a distance is measured. T0 is a pulse width in case of the near range.

In case of the far range, a distance is not measured within a portion that corresponds to the near range and a portion that corresponds to the middle range. Therefore, measurement needs to be performed in view of periods of time during which emitted light and reflected light pass through the portion that corresponds to the near range and the portion that corresponds to the middle range. More specifically, in case of the far range, a timing of measurement of partial component S1 in FIG. 3 is delayed by a period of time that corresponds to T0+3T0=4T0, and a distance is measured. 4T0 is a pulse width in case of the near range and a pulse width in case of the middle range.

Consequently, in case of the middle range and the far range, a distance is measured in view of the ranges within which a distance is not measured. Therefore, target object T is accurately measured in each of the ranges.

According to the above present exemplary embodiment, heat generated by imaging device 10 is decreased. Further, a distance from imaging device 10 to target object T is accurately measured within a range within which imaging device 10 makes images.

Further, since a number of pulses in case of the near range is smaller than a number of pulses in case of the middle range and a number of pulses in case of the far range, a total processing time is decreased.

Hereinafter, the reason will be described. For example, suppose that a predetermined distance that corresponds to a range within which a distance is measured is 50 m. Further, suppose that the near range is 10 m, the middle range is 30 m, and the far range is 10 m. If one kind of pulses is used to measure a distance within the whole predetermined distance, a pulse width is set to 5T0, considering the predetermined distance is the near range or the far range multiplied by five. 5T0 is pulse width T0 of the near range or the far range multiplied by five.

Further, a number of pulses is set to 100 for one kind of pulses that is used to measure a distance within the whole predetermined distance. 100 is a number of pulses that corresponds to the middle range in the present exemplary embodiment. In that case, a period of time taken by light receiver 12 to receive light is 5T0×100=500T0.

In the present exemplary embodiment, a pulse width is T0 and a number of pulses is 10 in case of the near range. A pulse width is 3T0 and a number of pulses is 100 in case of the middle range. A pulse width is T0 and a number of pulses is 200 in case of the far range. A total time taken by light receiver 12 to receive light is T0×10+3T0×100+T0×200=510T0.

In the present exemplary embodiment, the total time taken by light receiver 12 to receive light is 10T0 longer than a total time taken by light receiver 12 to receive light when one kind of pulses is used to measure a distance within the whole predetermined distance. Therefore, a difference between the total times taken by light receiver 12 to receive light is small. That is, since a number of pulses in case of the near range is smaller than a number of pulses in case of the middle range and a number of pulses in case of the far range, the total time taken by light receiver 12 to receive light is decreased.

If one number of pulses and one pulse width are used for each of the ranges, more specifically, if a pulse width is set to 3T0 and a number of pulses is set to 100 for each of the ranges, a total time for the three ranges is 3T0×100×3=900T0. Therefore, a processing time increases. Therefore, a frame rate may decrease.

In the present exemplary embodiment, however, a total processing time is decreased. Therefore, a total frame rate does not decrease. In other words, a frame rate is constant.

In the above exemplary embodiment, a number of pulses and a pulse width of emitted light are exemplified as the conditions under which imaging device 10 makes images. However, the present disclosure is not limited to the examples, and reflected-light component S0 may also be a condition under which imaging device 10 makes images. FIG. 7 illustrates variation in measured distances relative to measured distances. Curves L3, L4, L5 in FIG. 7 represent variation in measured distances in case of different reflected-light components S0. Reflected-light component S0 of curve L5 is larger than reflected-light component S0 of curve L4. Reflected-light component S0 of curve L4 is larger than reflected-light component S0 of curve L3.

Expression (5) described above and results illustrated in FIG. 7 show that larger reflected-light component S0, smaller variation in measured distances. Therefore, reflected-light component S0 of the far range is increased to be larger than reflected-light component S0 of the middle range. Consequently, accuracy of measurement in the far range is increased. For example, a larger number of exposures, a smaller f-number of a lens of light receiver 12, a stronger intensity of emitted light increases reflected-light component S0.

In the above exemplary embodiment, a number of pulses of emitted light is adjusted. However, the present disclosure is not limited to the example. An output of emitted light may be adjusted, for example. In that case, an output of emitted light may be increased to increase a number of pulses. Alternatively, an output of emitted light may be decreased to decrease a number of pulses.

In the above exemplary embodiment, there is one light source 11. However, the present disclosure is not limited to the example. There may be a first light source and a second light source. In that case, the first light source and the second light source may have respective different viewing angles.

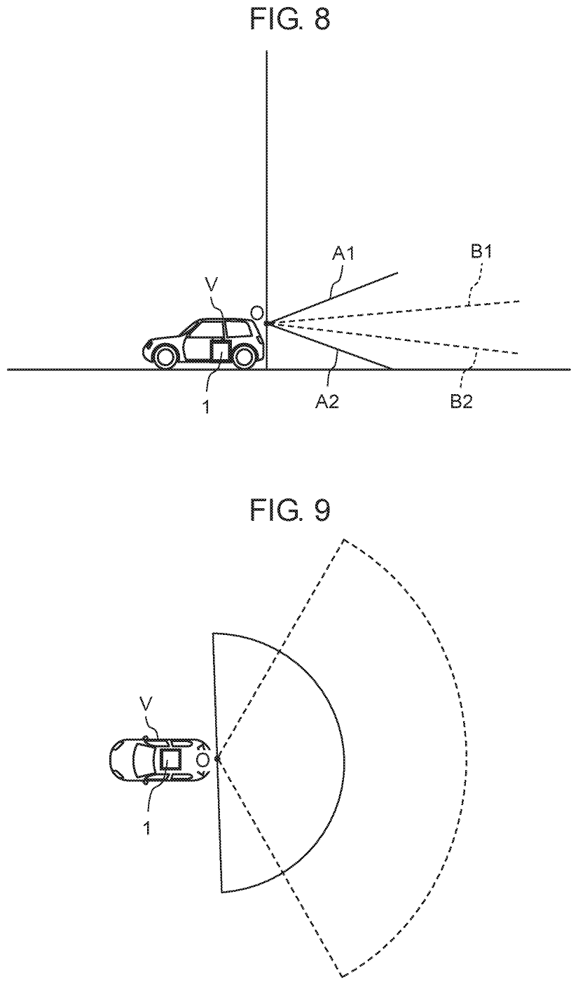

In an example illustrated in FIGS. 8 and 9, a viewing angle of the second light source is smaller than a viewing angle of the first light source. Point O in FIGS. 8 and 9 is a position of imaging device 10.

More specifically, in the example illustrated in FIG. 8, a range between solid line A1 and solid line A2 is a viewing range of the first light source in a vertical direction (a viewing angle is approximately 40°). A range between broken line B1 and broken line B2 is a viewing range of the second light source in the vertical direction (a viewing angle is approximately 10°). In the example illustrated in FIG. 9, a range surrounded by a solid line is a viewing range of the first light source in a lateral direction (a viewing angle is 180°). A range surrounded by a broken line is a viewing range of the second light source in the lateral direction (a viewing angle is 120°).

Consequently, the first light source illuminates a wide range in the vertical direction and the lateral direction. On the other hand, the second light source illuminates far in the vertical direction and the lateral direction. Therefore, the first light source is used for the near range, and the second light source is used for the middle range and the far range, for example.

Further, controller 110 turns off the first light source and turns on the second light source at a time of measurement of a distance within the far range and at a time of measurement of a distance within the middle range. When a distance from imaging device 10 to target object T is measured within the far range and within the middle range, target object T within a viewing range within the near range does not need to be considered. Therefore, an area outside the broken lines does not need to be illuminated. Therefore, in the present exemplary embodiment, light source 11 consumes less electrical energy since the first light source is turned off at a time of measurement of a distance within the far range and at a time of measurement of a distance within the middle range.

An order of measurement of the ranges is not described in the above exemplary embodiment. However, the order may be appropriately set in such a manner that the order corresponds to a purpose of distance measurement by means of distance measuring system 1. For example, to immediately measure a distance from imaging device 10 to target object T that lies relatively far, controller 110 may control light source 11 to cause distance measurer 120 to measure a distance within the far range, measure a distance within the middle range, and measure a distance within the near range in this order.

Alternatively, if it is intended that accuracy of measurement within the far range is increased, a frequency of measurement within the far range may be increased. For example, controller 110 may cause light source 11 to allow distance measurer 120 to perform measurement of the far range, measurement of the middle range, measurement of the far range, and measurement of the near range in this order.

A combination of a frequency of measurement and an order of measurement of the far range, the middle range, and the near range may be controlled based on directions of imaging device 10 (in front of, diagonally in front of, sideways from, diagonally behind, or behind the vehicle). An order of measurement of the ranges may be set in advance. For example, the order of measurement of the ranges may be set when a distance measuring system is shipped from a factory. Further, the order of measurement of the ranges may be appropriately changed.

In the above exemplary embodiment, the near range is set to 10 m, the middle range is set to 30 m, and the far range is set to 10 m. The present disclosure is not limited to the example. Distances of the ranges may be appropriately changed. For example, the near range may be set to 20 m, the middle range may be set to 20 m, and the far range may be set to 10 m.

In the above exemplary embodiment, the predetermined distance is divided into the three divided ranges. The present disclosure is not limited to the example. The predetermined distance may be divided into at least two divided ranges.

All or part of distance-measurement controller 100, controller 110, or distance measurer 120 in the above exemplary embodiment may be software, hardware, or software and hardware that work together. In such a case, the software is recorded on one or more non-transitory recording media such as a memory (such as ROM), an optical disk or a hard disk drive, and when the software is executed by a processor, the software causes the processor together with peripheral devices to execute the functions specified in the software. A system or apparatus may include such one or more non-transitory recording media on which the software is recorded and a processor together with necessary hardware devices such as an interface. Alternatively, all or part of distance-measurement controller 100, controller 110, or distance measurer 120 may be a physical circuit, such as a special integrated circuit (IC), or a special large-scale integration (LSI).

The above exemplary embodiment only shows a specific example of exemplary embodiments of the present disclosure. Therefore, it should not be understood that the above exemplary embodiment limits a technical scope of the present disclosure. That is, the present disclosure is applied in various forms without departing from a spirit of the present disclosure or essential features of the present disclosure.

A distance-measurement controller and a distance measuring system according to an aspect of the present disclosure decrease heat generated by an imaging device, and accurately measures a distance from the imaging device to a target object that lies within a range within which the imaging device makes images. Therefore, the distance-measurement controller and the distance measuring system according to an aspect of the present disclosure are useful.

What is claimed is:

1. A distance-measurement controller to be used with an imaging device, the imaging device including a light source that emits invisible light and a light receiver that receives reflected light, the reflected light being the invisible light that has been reflected by a target object, the distance-measurement controller comprising:
a controller that causes the light receiver to make images at a constant frame rate, and causes the imaging device to vary a condition for at least two divided ranges into which a range that is a predetermined distance from the imaging device is divided, the condition being a condition under which the images are made to measure a distance from the imaging device to the target object; and
a distance measurer that measures the distance from the imaging device to the target object, based on the reflected light.

2. The distance-measurement controller according to claim 1, wherein
the condition under which the images are made includes a condition of a number of pulses of the invisible light, and
at a time of measurement of the distance within a second range of the at least two divided ranges that is farther from the light source than a first range of the at least two divided ranges is, the controller causes the light source to emit the invisible light whose number of pulses is larger than a number of pulses of the invisible light emitted by the light source at a time of measurement of the distance within the first range.

3. The distance-measurement controller according to claim 2, wherein
the condition under which the images are made includes a condition of a pulse width of the invisible light, and
if the second range is narrower than the first range,
at the time of measurement of the distance within the second range, the controller causes the light source to emit the invisible light whose pulse width is smaller than a pulse width of the invisible light emitted by the light source at the time of measurement of the distance within the first range.

4. The distance-measurement controller according to claim 2, wherein
at a time of measurement of the distance within a third range of the at least two divided ranges that is closer to the light source than the first range of the at least two divided ranges is, the controller causes the light source to emit the invisible light whose number of pulses is smaller than the number of pulses of the invisible light emitted by the light source at the time of measurement of the distance within the first range.

5. The distance-measurement controller according to claim 4, wherein
the condition under which the images are made includes a condition of a pulse width of the invisible light, and
if the third range is narrower than the first range,
at the time of measurement of the distance within the third range, the controller causes the light source to emit the invisible light whose pulse width is smaller than a pulse width of the invisible light emitted by the light source at the time of measurement of the distance within the first range.

6. The distance-measurement controller according to claim 1, wherein
the light source includes a first light source and a second light source, and
the controller controls the first light source and the second light source so as to allow the second light source to emit the invisible light whose viewing angle is smaller than a viewing angle of the invisible light emitted from the first light source.

7. The distance-measurement controller according to claim 6, wherein
the condition under which the images are made includes a condition of a number of pulses of the invisible light, and
at a time of measurement of the distance within a first range of the at least two divided ranges, the controller causes the light source to emit the invisible light whose number of pulses is smaller than a number of pulses of the invisible light emitted by the light source at a time of measurement of the distance within a second range of the at least two divided ranges that is farther from the light source than the first range is, and
the controller turns off the first light source and turns on the second light source at the time of measurement of the distance within the second range.

8. A distance measuring system comprising:
an imaging device that includes:
a light source that emits invisible light; and
a light receiver that receives reflected light that is the invisible light that has been reflected by a target object; and
a distance-measurement controller that includes:
a controller that causes the light receiver to make images at a constant frame rate, and causes the imaging device to vary a condition for at least two divided ranges into which a range that is a predetermined distance from the imaging device is divided, the condition being a condition under which the images are made to measure a distance from the imaging device to the target object; and
a distance measurer that measures the distance from the imaging device to the target object, based on the reflected light.
